(19) United States
(12) Patent Application Publication
(10) Pub. No.: US 2022/0294325 A1
(43) Pub. Date: Sep. 15, 2022

(54) STATE-CHANGE ROTATIONAL MAGNETIC FIELD TENSOR ENERGY HARVESTING GENERATOR

(71) Applicant: David Deak, SR., Suffern, NY (US)

(72) Inventor: David Deak, SR., Suffern, NY (US)

(21) Appl. No.: 17/553,643

(22) Filed: Dec. 16, 2021

Related U.S. Application Data
(60) Provisional application No. 63/126,417, filed on Dec. 16, 2020.

(51) Int. Cl. H02K 35/02; H02K 7/18

(52) U.S. Cl. CPC H02K 35/02; H02K 7/1853

(57) ABSTRACT

The present disclosure is of energy harvesting generators producing power to electrical loads by a novel method of a “state-change” tensor component of the magnetic field intensity of a Neodymium spherical magnet; and the accumulative directional Lorentz Force created by a moving high permeability magnetic steel toroid bi-directional guide that causes multi degrees of rotational freedom on the spherical Neodymium magnet. This action of the “state-change” Lorentz Force tensor, is caused by a sudden “state-change” in the position of the moving high permeability magnetic steel toroid, when the spherical Neodymium magnet is surrounded by an electric coil. This action produces an induced current to flow when the coil is connected to an electric load, and this action produces a voltage drop across the electric load.

This application claims the benefit of and priority from United States provisional patent application Ser. No. 63/126,417 filed on Dec. 16, 2020, which is incorporated herein for all purposes, in its entirety.

### CROSS REFERENCE TO RELATED APPLICATIONS

Also incorporated herein by reference, in their entireties, are U.S. patent application Ser. No. 16/675,401 filed on Nov. 6, 2019, and titled Offset Triggered Cantilever Actuated Generator, which is based on provisional application serial number Ser. No. 62/876,621, filed on Jul. 20, 2019.

### FIELD OF DISCLOSURE

This disclosure relates to electromagnetic energy harvesting generators that utilizes a single non-focused magnet to produce electrical energy.

### BACKGROUND ART

Current classifications of low power (<10 watts) output energy harvesting generators are of the electromagnetic type, solar type, piezoelectric type, and Coulomb Transition Force types. Of these, the focus of this invention is on the electromagnetic type and a novel methodology of utilizing the laws of Faraday, Lenz, Maxwell, and Einstein's Special Theory of Relativity relating to electrodynamic systems.

### SUMMARY OF THE DISCLOSURE

In accordance with a first embodiment, a single non-focused magnet, which may be spherical but is not so limited is triggered into motion by a magnetic trigger-coupling of at least two varying distance (proximal to distal) situated magnets that are in pole repulsion so as to drive a mechanical complex offset cantilever leverage system. The system moves a magnetic steel toroid through a finite limited distance. The magnetic steel toroid is disposed proximal to the. The magnet is centrally disposed within an electric coil bobbin that is wound with a plurality of wire winding members to produce electrical energy upon activation of the variable proximal repulsion aligned trigger-coupling magnets when an external force moves at least a first coupling magnet. This instantly cause a second magnet, aligned in repulsion pole situation, to move away from the first repulsion magnet member and to transfer its momentum to a complex cantilever leverage system that pushes the magnetic steel toroid across the proximally disposed magnet. This produces electrical energy when the magnet, that is disposed centrally within the electrical coil, is set into bi-directional motion, and that magnet's magnetic flux field lines of force interact by cutting through the coil windings and by Faraday's and Lenz's laws, produces electrical energy to be utilized for any useful application.

Thus, one important novel feature of this disclosure is generating electrical energy from a first embodiment of a single non-focused magnet, with a plurality of degrees-of-freedom, which can be, but is not limited to a spherical magnet that is triggered into motion by a magnetic trigger-coupling of at least two variable proximally situated trigger-coupling magnets, that are in pole repulsion, to drive a mechanical complex offset cantilever leverage system. The cantilever leverage system moves a magnetic steel toroid through a finite proximal distance. The magnetic steel toroid is disposed proximal the magnet that is centrally disposed within an electric coil bobbin that is wound with a plurality of wire winding members; to produce electrical energy upon activation of the variable proximal repulsion aligned trigger-coupling magnets when an external force moves at least a first coupling magnet that instantly causes a second magnet, aligned in repulsion pole situation, to move away from the first repulsion magnet member that transfers its magnetic force of repulsion to a complex cantilever leverage system that pushes the magnetic steel toroid across the proximal disposed spherical magnet, disposed within the coil bobbin's centre that produces electrical energy when the spherical magnet that is disposed centrally within an electrical coil, and that spherical magnet's magnetic flux field lines of force interacts at 90 degrees with the coil windings by Faraday's and Lenz's law produces electrical energy to be utilized for any useful application.

Another novel feature of the disclosed embodiments is generating electrical energy from a moving magnet by a magnetic-to-mechanical triggering system. The magnet-to-mechanical triggering system is comprised of two small disk magnets disposed and movable with respect to each other in a pole repulsion arrangement where a first magnet is in periodic communication with an external mechanical force applied to the first disk magnet. The first disk magnet is disposed and fixed within a bendable hinge support member that has a horizontal (referenced to the bottom of the generator's enclosure) rest position before triggering. The first disk magnet is horizontally orientated proximal to a second disk magnet that is horizontally orientated with the first disk magnet; and the second disk magnet is disposed and fixed within its holding compartment that is part of a first rotating horizontal primary drive link lever and a second connected rotating tangential complex-axle extension lever whereby both first and second lever elements mentioned are in sequential mechanical communication with a horizontally sliding magnetic steel toroid support substrate where the magnetic steel toroid is disposed and fixed with the sliding magnetic steel toroid substrate. The sliding magnetic steel toroid substrate and its fixed magnetic steel toroid moves across the spherical magnet disposed with the center of the coil bobbin and its windings. This action of the magnetic steel toroid moving proximal over the spherical magnet causes a plurality of angular degrees of rotation of that spherical magnet. During a triggering sequence, that action of an externally applied force on the first magnet and its horizontally bendable holding compartment instantly bends the holding compartment and magnet downward. By design, the first and second disk magnets are poled in repulsion order, so that when the first disk magnet's magnetic field lines of force repel the second magnet's magnetic field lines of force thereby both magnets and their support members instantly move in unison downward and upward with increasing and decreasing applied external force.

Another novelty of this invention is that the energy harvesting generator is operational in an omni-directional stable “state-change” rotational position in three-dimensional space within the center of the coil by a novel technique of utilizing a thin (0.03 mm) strip metallic glass slip clutch, positioned proximal under the spherical magnet and disposed in a recessed compartment in the bottom of the coil bobbin and in a plane parallel and distally opposite to the magnetic steel toroid slidable substrate. The magnetic steel toroid retains, by magnetic attraction, the spherical magnet in position, until a triggering sequence is executed; and in addition the metallic glass thin slip clutch strip is moderately attracted to the spherical magnet with such a value to allow for the magnet to rotate whilst under the influence of the magnetic steel toroid. The novel slip clutch serves the purpose of keeping the spherical magnet stable when the generator embodiment encounters omni-directional movement in three dimensions.

The metallic glass slip clutch is disposed proximal under the bottom surface of the coil bobbin opposite the coil bobbin top surface that has disposed a slidable magnetic steel toroid substrate. As the magnetic steel toroid passes over and away from the spherical magnet, the magnet is influenced by induced magnetic attraction eigen vector to the spherical magnet so that the spherical magnet's directional tensor changes the eigen vector by the “state-change” magnetic attraction induced eigen value. The action of the magnetic steel toroid moving bi-directionally over the spherical magnet produces the “state-change” rotational eigen values of the magnet's rotational eigen vectors. This action causes directional eigen vector values of the spherical magnet's lines of flux to change and pass through the coil windings, which is part and partial to the induced electron charge flow (current) through an electrical load that is part of a complete closed electrical circuit between the load and the generator, which in turn produces a voltage drop across the electrical load.

Metallic glasses have high permeability, and for this low thickness (thin 0.03 mm) example as compared for a low thickness example to magnetic steel, the metallic glass exhibits a substantially lower magnetic flux reluctance by comparison. The metallic glasses consist essentially of about 66 to 82 atom percent iron, from 1 to about 8 atom percent of the iron being, optionally replaced with nickel and/or cobalt, about 1 to 6 atom percent of at least one element selected from the group consisting of chromium, molybdenum, tungsten, vanadium, niobium, tantalum, titanium, zirconium and hafnium, about 17 to 28 atom percent of boron, 0.5 to 6 atom percent of said boron being, optionally, replaced with silicon and up to 2 atom percent of boron being, optionally, replaced with carbon, plus incidental impurities. Such metallic glasses are especially suited for use in tape heads, relay cores, transformers; and in the present invention it is used to provide an acoustic noise impedance for a quiet rotation of the spherical magnet and also to allow the generator to function properly in any direction either aiding or opposing gravitational influence.

but not limited to a spherical magnet, that is triggered into motion by a coupling of at least two distally situated magnets that are in pole repulsion to drive a mechanical complex offset cantilever leverage system that moves a magnetic steel toroid through a finite proximal distance and where the magnetic steel toroid is disposed proximal in reference to the spherical magnet that is centrally disposed within an electric coil bobbin that is wound with a plurality of wire winding members; to produce electrical energy upon activation of the distal repulsion aligned magnet coupling magnets.

The generator is operational in an omni-directional position in three-dimensional space by a novel technique of utilizing a metallic glass slip clutch that retains the spherical magnet in position, until a triggering sequence is executed.

### BRIEF DESCRIPTION OF THE INVENTION DRAWINGS

FIG. 1 is a perspective drawing of an embodiment that can be utilized for fitting into a standard heel of a shoe.

FIG. 1A is an exploded, perspective drawing of several components for the generator embodiment of FIG. 1. FIG. 2a is a perspective drawing of the embodiment of FIG. 1 disposed in a shoe heel.

FIG. 2b is a top perspective view of the embodiment of FIG. 2a disposed in a shoe heel.

FIG. 3a is an exploded top perspective view of the shoe generator with all components labeled.

FIG. 3b is an exploded side perspective view of the shoe generator with all components labeled.

FIG. 4a is a right CAD view of the shoe generator in a non-triggered rest state.

FIG. 4b is a right CAD view of the shoe generator in an initial triggering of the shoe generator with some form of external (not shown) force being applied that starts motion of the triggering components.

FIG. 4c is a right CAD view of the shoe generator in final downward phase of triggering the shoe generator with some form of external (not shown) force being applied that is the end phase of downward motion of the triggering components; and then the reverse movement takes place when the force is stopped.

FIG. 5a is a perspective view of a second embodiment for a non-shoe application; and it is a slide-triggered type of generator in and enclosure and used as a battery-free slide switch transmitter.

FIG. 5b is a perspective view of the stand-alone second embodiment generator for OEM applications.

FIG. 5c is a perspective view of the generator switch second embodiment with top cover removed.

FIG. 5d is a right-side cutaway view of the enclosed generator second embodiment with its slider in an OFF position.

FIG. 5e is a right-side cutaway view of the enclosed generator second embodiment with its slider in an ON position.

FIG. 6a is a right-side view of the shoe type generator preferred first embodiment in a pre-triggered rest state that illustrates the spherical magnet's rest position, under tension, because of the magnetic steel toroid position; where the applied force is zero and its angle relative to the horizon is zero degrees.

FIG. 6b is a right-side view of the shoe generator preferred first embodiment with an initial trigger state where an external force is greater than zero and the trigger plate has a non-zero angular position.

FIG. 6c is a right-side view of the shoe generator preferred first embodiment with an continuation trigger state where an external force is much greater than zero and the trigger plate has a non-zero angular position when the applied force is increased to the limit of the trigger system movement.

FIG. 7a is a drawing illustrating the static magnetic field set up between the magnetic steel disk and a Neodymium spherical magnet.

FIG. 7b is a drawing illustrating the contrasting magnetic field changes when there is a magnetic steel disk that contains a centre through hole and how the associated magnetic field has a profound increase in field concentration compared to FIG. 7a.

FIG. 8 is an exploded view of all the components of a second embodiment of the invention utilized for consumer and commercial battery-less and wireless slide-switches with the added feature of being hermetically sealed.

FIG. 9 is an illustration relating to the detailed explanation for why the magnetic field between two magnets or a magnet and a magnetic steel object varies to the inverse cube of the separation distance as opposed to the erroneous inverse square of the distance.

FIG. 10a is a tri-projection illustration of the second embodiment utilized as a slide hermetically-sealed switch transmitter.

FIG. 10b is a reference illustration to describe the cutaway view of FIG. 10c.

FIG. 10c is the cutaway view across the span A-A of the second embodiment.

### DETAILED DESCRIPTION OF THE DRAWINGS

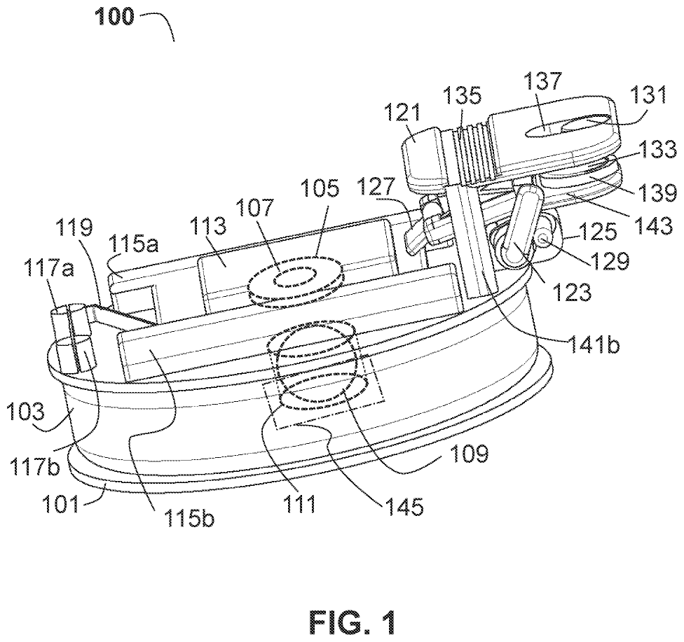

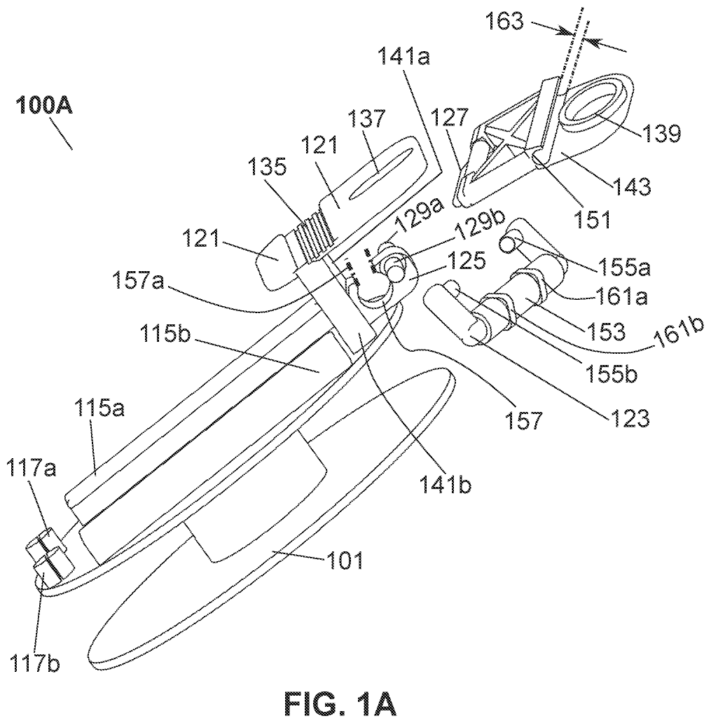

In FIG. 1 and FIG. 1A the preferred embodiment 100 of the present disclosure of the invention shows a detailed perspective view of all components composing the energy harvester that is functional for inserting in a shoe heel and for a plurality of other energy harvesting applications addressing battery-free utilization. The generator is comprised of a coil winding 103 wound on a novel coil bobbin 101 that is comprised with features such as dual guide channels 115a & 115b that define a channel wherein a disposed sliding substrate 113 that contains a magnetic steel toroid 105 that has a through hole 107 is disposed. The toroid is fixed centrally within the sliding substrate 113. This sliding substrate 113 with its fixed magnetic steel toroid 105 is free to move bi-directionally within its guide channels 115a & 115b and is limited in its total bi-directional travel path horizontally by the coil bobbin's first limit stop section 125. Stop section 125 has a dual function as the coil bobbin's first limit stop section 125 for the sliding substrate 113 and as an axle channel through a hole 157 (see FIG. 1A) for receiving and being rotationally free in mechanical communication with the axle central section 153 (see FIG. 1A), that is the central section 153 of q complex axle 123. The complex axle 123 is set in place and free to rotate within the complex axle channel through hole 157 of coil bobbin's first limit stop section 125 and it is inserted by a “snap-in” insertion action, because the through hole has an opening slightly smaller than the diameter of the snap-in complex axle central section 153.

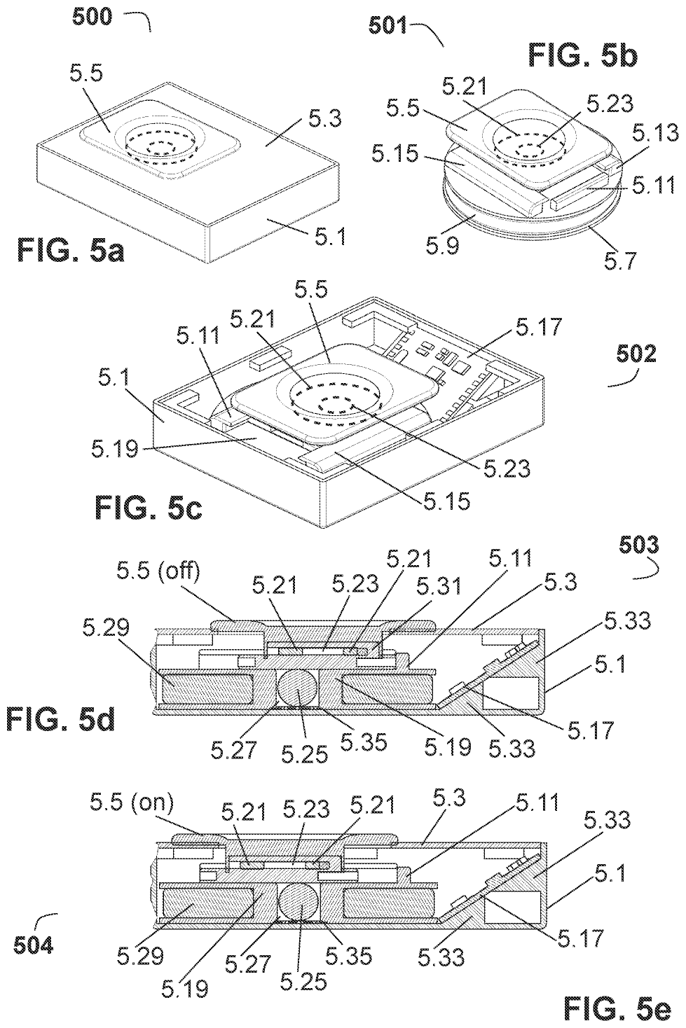

In FIG. 1 the magnetic steel toroid sliding substrate 113 has a second movable stop Z-shaped or ZED spring 119 comprised of springy steel and serves as a counter force against the triggered sliding movement of the substrate 113. Ergo, when an external force is applied to the bendable top first repelling disk Neodymium magnet's 131 compartment 137 disposed as an elongated blind hole within the bendable and angular changing top horizontal lever platform 121, the magnetic repulsion between the top first repelling disk Neodymium magnet 131 and the bottom repelling second Neodymium disk magnet 133 disposed in its compartment 139 as part of the complex movable and rotatable horizontal elongated lever platform 143, this repulsion has the rotatable lever moving slightly downward and shifting horizontally forward and this movement is sustained by the instant response movement of the slave complex axle 123. As the external force increases and causes more downward movement of the bendable and angular changing top horizontal lever platform 121, the sequential force reaction is that the tip section 127 of the complex movable and rotatable horizontal elongated lever platform 143 moves forward pushes against the slidable magnetic steel toroid 105 substrate 113. During the forward pushing action over time, the ZED spring 119 is bending as a compression spring until the ZED spring 119 compressed force overcomes the external input force. Then the magnetic toroid 105 in its substrate 113 moves back over the magnet 109 and causes, by magnetic flux induction, the magnet's 109 flux lines (not shown) to pass through the coil winding and in a closed electrical circuit with the generator and electrical load 5.17 (electrical load=ISM Band transmitter, shown in FIG. 5c as 5.17) there is electron charge flow; thus developing a voltage across the load input power terminals of the transmitter module 5.17 (electrical load=ISM Band transmitter, shown in FIG. 5c as 5.17). To summarize a power generation process:

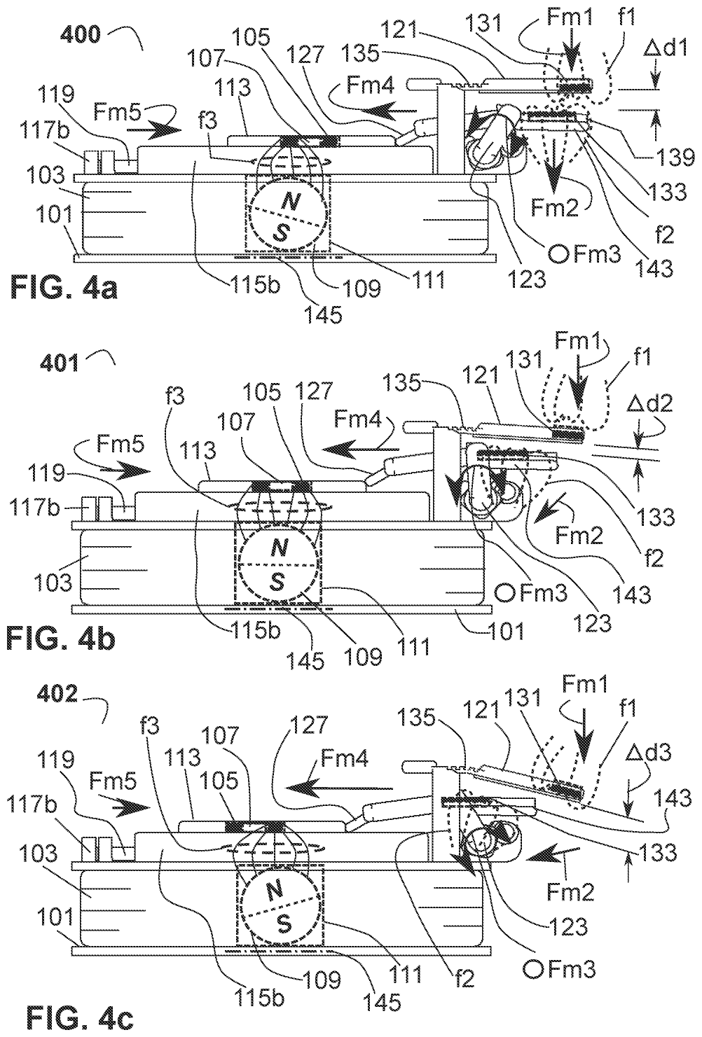

Step [1] An external applied force acting on the bendable and angular changing top horizontal lever platform 121 section that contains a first repelling disk magnet 131 with a repelling magnetic field (f1 in FIG. 4a) that pushes against a bottom repelling second disk magnet 133 that is contained in a complex movable and rotatable horizontal elongated lever platform 143. This action causes a forward and slight downward motion of the first horizontal lever platform.

Step [2] The complex movable and rotatable horizontal elongated lever platform 143 moving forward has its tip section 127 to come into mechanical communication and pushing both simultaneously the sliding substrate 113 with its contained magnetic steel toroid 105 forward (to the left in the drawings).

Step [3] This causes the magnetic steel toroid 105 to slide, with its slidable substrate 113, over the magnet 109 that is free to rotate within in the center of the coil bobbin's 101 blind hole 111.

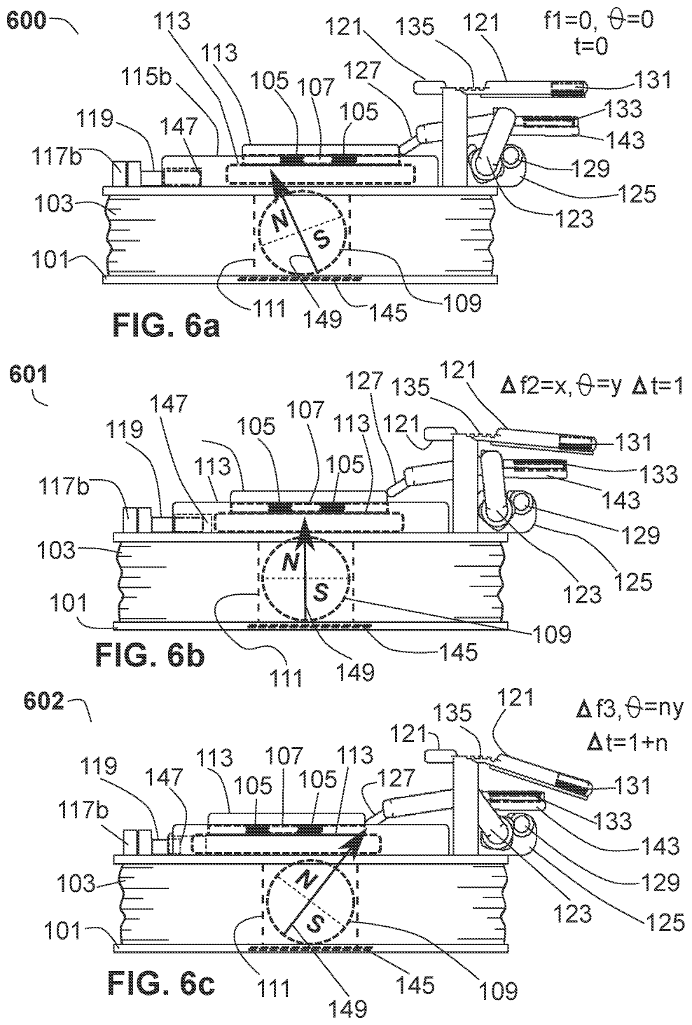

Step [4] As the spherical magnet 109 moves in the bobbin's 103 centre blind hole 111, which is caused by the induced magnetic attraction (non-contact) between the magnetic toroid and the spherical magnet, the spherical magnet's 109 magnetic flux lines (shown in FIG. 6a, b, &c B as 149) pass through the coil winding 103 and induces a voltage drop across the coil winding terminals (when connected to an electrical load).

Step [5] Simultaneously as this action ([1] to [4]) takes place, the forward moving magnetic steel toroid substrate 113, with its magnetic steel toroid 105, progressively moves forward all the while pushing and compressing the fixed ZED spring 119.

Step [6] As step [5] happens, the total movement continues until the input external applied force moves the complex movable and rotatable horizontal elongated lever platform 143 past its limit point that is defined as the tip pushing the magnetic steel toroid substrate 113 until the ZED spring 119 is fully compressed to its mechanical compression limit. The system is designed and configured to perform in this manner without any dynamic restrictions other than that of the limits of the maximum mechanical travel for the lever and for the maximum compression for the ZED spring 119.

Step [7] After step [6], the compressed ZED spring 119 releases its stored potential energy into kinetic energy that pushes back on the magnetic steel toroid substrate 113 in a direction opposite to the initial forward pushing sequence.

Step [8] The action of the ZED spring 119 pushing back on the magnetic steel toroid substrate 113 causes the magnetic steel toroid's 105 travel to moves the spherical magnet 109 in an opposite rotating action and this opposite movement causes the magnetic flux lines (shown in FIG. 6a, b, &c B as 149) to pass through the coil winding 103 in an opposite direction and produces an opposite voltage polarity to appear across the coil winding 103 terminals.

Step [9] this process is seen as a motion oscillation between the input external applied kinetic energy force that transfers that kinetic energy force into a potential energy compression force and the balance of this energy exchanges in the movement simultaneously has the magnetic steel toroid 105 influencing the rotation of the centred spherical magnet 109 to produce a momentary oscillatory action that in turn produces an alternating voltage potential felt at the coil winding 103 terminals.

After the magnetic steel toroid 105 moves past the spherical magnet's 109 overhead area where the cooperative magnetic attraction between the magnetic steel toroid 105 and the spherical magnet 109 becomes weak enough to have the spherical magnet 109 only be influenced by gravitational forces, the spherical magnet 109 rotates back for its previous position of momentary non-movement. This is the time that the voltage output of the coil 103 goes to zero. This action is bi-directional and cyclic resulting in a positive increasing and decreasing voltage then going through zero volts and into a negative increasing and decreasing voltage, every time triggering occurs for an external force applied to the bendable and angular changing top horizontal lever platform 121.

FIG. 1A is a perspective drawing 100A of several components for the generator embodiment that shows the overall features of three components two of them are snap-in members and the preferred material of construction is ABS plastic with 30-40% glass fibers for strength and durability, namely; [a] the coil bobbin 101 that has subcomponents; two ZED spring slit cylinder protrusions 117a & 117b to hold the ZED Spring 119, [b] also on the coil bobbin 101 is the bendable and angular changing top horizontal lever platform 121 with its plurality of serrations 135 that provides the degree of bendability for the platform 121.

[c] the complex axle coil bobbin's first limit stop section 125 that is an complex axle channel through hole 157 with an open section 157a and there are two complex axle stop protrusions 129a & 129b to limit the backward travel of the complex axle 123. The complex axle centre axle partition 153 that is centrally defined by its square protrusions 161a & 161b on each side of the central axle partition 153 to insure the axle partition 153 maintaining its centre position once it is snapped into the receiving complex axle channel through hole 157 and then it is free to rotate a plurality of degrees between the stop protrusions 129a & 129b.

[d] The complex movable and rotatable horizontal elongated lever platform 143 with its subcomponents of; the forward tip protrusion 127 whose purpose is to push against the slidable magnetic steel toroid contained substrate to advance it over and past the disposed spherical magnet for bi-directional magnetic steel toroid travel and simultaneously the spherical magnet rotation. Also it has an elongated through hole 151 with its partial open section 163 to allows for the snap-in insertion of the complex axle's dual end axle protrusions 155a & 155b, allows the horizontal lever platform component to rotate about the dual end axle protrusions 155a & 155b.

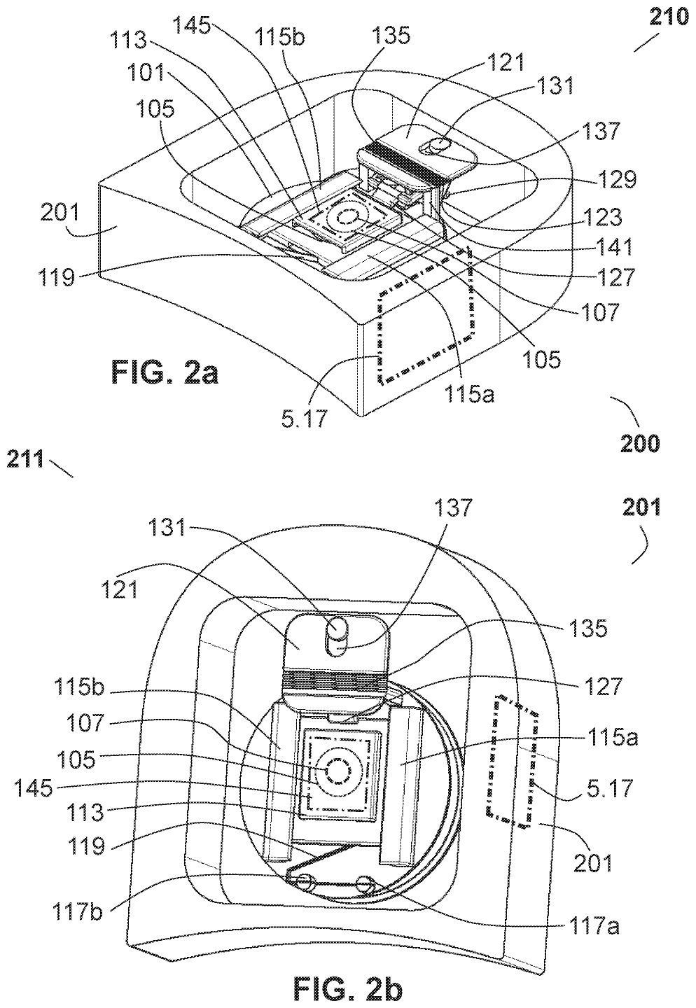

FIG. 2a is a three dimensional perspective frontal view 210 and a top perspective view 211 of the preferred embodiment of an energy harvesting generator that is fitted into a shoe heel for many applications including a ID and wearer tracking for nursing homes, human tracking in general, and for gathering ID and other information for the athletic shoe markets. This embodiment (the generator as shown in FIG. 1 as 100) is fitted into a typical shoe heel 201 and is electrically connected to a typical ISM Band transmitter module (as shown FIG. 5a as module 5.17 and this drawing) and the preferred embodiment within the shoe heel 201 supplies power to operate the transmitter 5.17 in a manner that with every step of the wearer, the transmitter is powered and sends a coded radio telegram containing digital identification and other digital information that is received by a remote receiver for transmitted information. The triggering of this embodiment has its bendable and angular changing top horizontal lever platform 121 containing a small permanently disposed first repelling disk Neodymium magnet 131 and the bendable and angular changing top horizontal lever platform 121 is in mechanical communication with the bottom surface of the sole of a shoe (not shown). Every time the wearer takes a step, continuously walks, or runs; downward mechanical force from the weight of the wearer pushes downward on the bendable and angular changing top horizontal lever platform 121 with its disposed first repelling disk Neodymium magnet 131 that is in a like magnetic pole repelling arrangement with a bottom repelling second Neodymium disk magnet 133 (not shown in this figure but shown in FIG. 1 and other figures in this document), and this like repelling magnetic pole arrangement instantly transfers the initial downward stepping force to the bottom repelling second Neodymium disk magnet 133 that is disposed in the magnet compartment 139 of the complex movable and rotatable horizontal elongated lever platform 143 (as shown in FIG. 1 and other figures in this document). This instant acting force transfer moves the horizontal lever platform forward and simultaneously the forward movement instantly rotates about the complex axle's dual end axle protrusions 155a & 155b. This forward movement about the complex axle's dual end axle protrusions 155a & 155b also rotates the complex axle 123 along with its movement because of the mechanical connection between the complex axle's dual end axle protrusions 155a & 155b that is snap-in inserted and free to rotate in the horizontal lever platform's elongated through hole 151 with its open section 163 that allows the snap-in connection. Also the movement forward of the complex movable and rotatable horizontal elongated lever platform 143 has its forward tip section 127 that is in mechanical communication with the slidable magnetic steel toroid 105 substrate 113 causes the slidable magnetic steel toroid substrate 113 and its inserted fixed magnetic steel toroid 105 to pass over proximal, the spherical Neodymium magnet 109 and this cause the spherical magnet 109 to rotate a plurality of angular degrees of rotation. As the magnetic steel toroid 105 passes distal over the spherical magnet 109, the spherical magnet rolls back to its rest position the spherical magnet's flux lines pass through the coil winding 103 and electrical energy is generated with a noted polarity with reference to direction of motion. During this process, once there is a discontinuation of this applied external force to the bendable and angular changing top horizontal lever platform 121 the reverse action takes place on the sliding magnetic steel toroid substrate 113 by energy stored (potential energy) in the ZED compression spring 119 is released and pushes the sliding substrate 113 in the opposite direction that now has its magnetic steel toroid 105 proximally pass over the spherical magnet 109 and the spherical magnet 109 rotates a plurality of degrees of angular rotation and this action causes the magnet flux lines pass through the coil winding 103 and electrical energy is generated with a noted polarity with reference to direction of motion that is opposite in polarity with the first action instance.

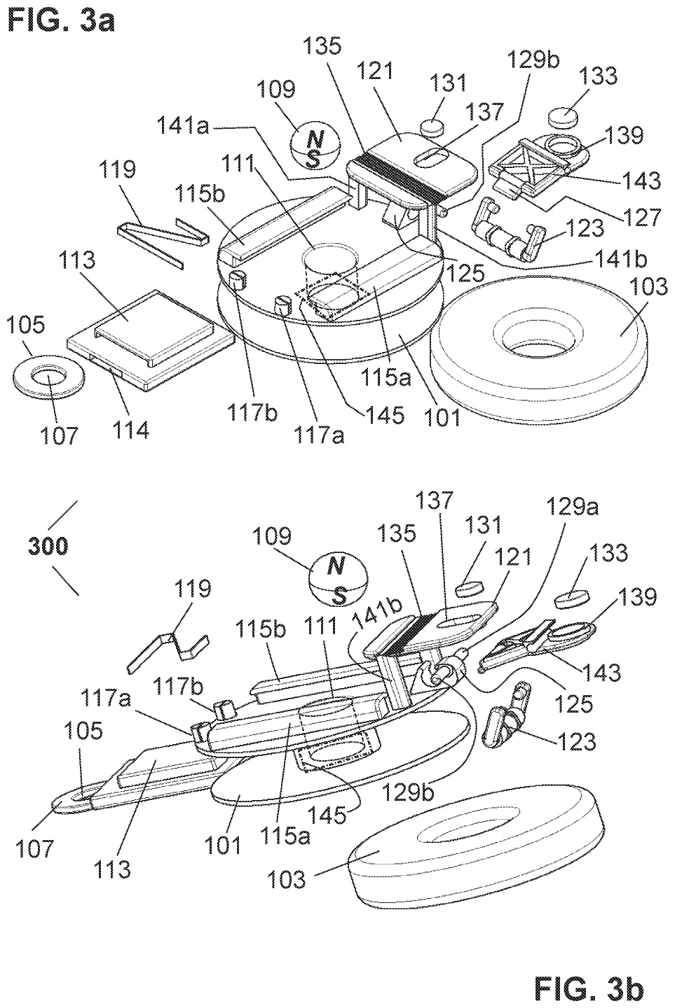

FIG. 3a and FIG. 3b are exploded frontal and right-side perspective view of the preferred embodiment of the present invention showing all the system components without the shoe heel 201 that is shown in FIGS. 2a & 2b. The system components are: coil bobbin 101, coil winding 103, magnetic steel toroid 105 with centre through hole 107, Neodymium spherical magnet 109, blind hole for the Neodymium spherical magnet 111, the sliding magnetic steel toroid substrate 113, the dual slide rails 115a & 115b, the ZED spring dual holding cylindrical protrusions 117a & 117b, the ZED spring 119 that is partially fitted, on one end, into its rectangular blind hole 114, the bendable and angular changing top horizontal lever platform 121, the coil bobbin's first limit stop section 125 that is the seat for the complex axle 123, the tip protrusion 127 on the complex movable and rotatable horizontal elongated lever platform 143 that also has its bottom repelling second Neodymium disk magnet 133 disposed in its magnet compartment 139, also there are the dual opposite end protrusions 129a & 129b that act as stops for the complex axle 123 movement, the bendable platform section 135, the horizontal platform's first magnet compartment 137 that is elongated so the first magnet's position can be adjusted for a plurality of positions that affects trigger sensitivity, the twin pillars 141a & 141b that support the bendable and angular changing top horizontal lever platform 121, and the thin (0.03 mm) metallic glass strip 145 that is substantially attracted by magnetic induction and proximal separated by the bottom blind hole thin blind end to the spherical magnet 109 to allow for uniform operation in any position in three dimensional space by being proximally attracted to the spherical magnet 109; and it also retards the spherical magnet's 109 rotation to lengthen the time duration of the generated waveform, thus reducing the frequency of the voltage waveform generated and increasing its ringdown time, which allows for an substantial increase in useable operational time that can allow for more data to be transmitted for greater use in the case of the transmitter being a transceiver and in some applications can be powered long enough for a return annunciation signal sent from the remote control transceiver in cases where safety is demanded. The retardation of the time duration results in performing a Fourier analysis of the waveform and then taking the Laplace transform to identify a damped sinewave:

y(t)=A·e^{-λt}·(cos(ωt+ϕ)+(sin(ωt+ϕ)))

y(t)=A·e^{-λt}·(cos(ωt+ϕ))

### Where:

A is the initial amplitude (the highest peak),
λ is the decay constant,
φ is the phase angle (at t=0)
ω is the angular frequency.

The mathematical relationship is that the lower the frequency of the sinewave generated, the longer the Laplace intrinsic damping factor, which in effect produces a longer period for generating usable electrical power to operate the transmitter module.

FIG. 4a is a right side view of the preferred embodiment of the present invention that relates to the applied force and consequently the resultant pushing drive forces that instantly causes the rotation of the Neodymium spherical magnet 109 in the centre of the coil winding 103; and thus generating electrical energy as a resultant. FIG. 4a is the initial start state when an initial external force Fm1 is applied to the bendable and angular changing top horizontal lever platform 121 that contains a first repelling disk Neodymium magnet 131 and this magnet has a first repelling magnetic field f1 relative to the second repelling magnetic field f2 of a bottom repelling second Neodymium disk magnet 133 disposed in the magnet compartment 139 of the complex movable and rotatable horizontal elongated lever platform 143. There is a resultant downward force Fm2 with a magnitude that equals the total product of the two magnetic repelling flux divided by the cube of the distance between the two magnets 131 and 133 {(f1×f2)/d³}.

The separation distance Δd1 (delta d1) produces two other vector force components of interest that are a horizontal force Fm4 and an anti-clockwise rotational force Fm3 acting on the complex axle 123; whereby as the external force Fm1 increases to push the bendable and angular changing top horizontal lever platform 121 further downward, the complex movable and rotatable horizontal elongated lever platform 143, under the influence of the lateral force Fm4, moves forward (as left movement on FIG. 4a's right hand view) with its tip member section 127 that comes in mechanical contact with the sliding magnetic steel toroid substrate containing the magnetic steel toroid 105 that has a centre through hole 107. This action causes the magnetic steel toroid to move proximally over the Neodymium spherical magnet 109 and the magnet now starts to rotate, and its magnetic field begins moving to start passing through the coil winding 103. During this time, the spherical magnet 109 is right angled and the magnetic steel toroid 105 with its centre through hole is centred over the spherical magnet 109. During this time FIG. 4b shows the action that takes place, whilst the external force is increasing and the separation distance A d1 (delta d1) decreases and further moves all of the affected components: complex movable and rotatable horizontal elongated lever platform 143, complex axle 123, and the sliding magnetic steel toroid substrate 113 with its magnetic steel toroid 105 increasingly forward (as increased left movement on FIG. 4a's right hand view). All the action so far with FIG. 4a and FIG. 4b has an additional increasing compression of the ZED spring transferring most of the kinetic energy of the FIG. 4a and FIG. 4b process into potential energy of compression and as an instance of external applied force Fm1 decreasing to zero force, or instantly being removed; as shown in FIG. 4c, the compressed ZED spring is free to move exchanging its stored potential energy into the kinetic energy of motion forward in the opposite direction, pushing back on the sliding magnetic steel toroid substrate 113 with its magnetic steel toroid 105 with the centre through hole 107. This reverse action causes the magnetic steel toroid 105, with its centre through hole, to move over proximally, by magnetic attractive induction, the Neodymium spherical magnet 109 and the Neodymium spherical magnet's 109 magnetic flux passes through the coil winding 103 in a direction opposite that of the instance during the actions associated in FIG. 4a and FIG. 4b. In the instances associated with FIG. 4a to FIG. 4b the rotating of the Neodymium spherical magnet 109 a plurality of degrees rotation and this rotation cause its magnetic flux lines pass through the coil winding 103 in a first direction, thus producing an induced positive electrical potential across the coil winding's end terminals (terminals not shown). In the instances associated with FIG. 4b to FIG. 4c the rotating of the Neodymium spherical magnet 109 a plurality of degrees rotation and this rotation cause its magnetic flux lines to pass through the coil winding 103 in a second direction opposite to that of the first direction, thus producing an induced negative electrical potential across the coil winding's end terminals (terminals not shown).

FIG. 5a illustrates second embodiment 500 of the present invention not related to a shoe-heel energy harvesting generator as in previous illustrations in this document. The second embodiment 500 is complete as a slide action electrical generator with an ISM Band digital coded transceiver module comprised of a device enclosure 5.1 with a top cover plate 5.3 and a slide type button 5.5 whose function is to turn ON and OFF a remotely located electrical load, by sending a radio telegram with digital information, to at least one encoded receiver (not shown) to decode the functional information for ON and OFF operation of that electrical load.

FIG. 5b illustrates the basic stand-alone energy harvesting generator 501 that is comprised of: a coil bobbin 5.7, a coil winding of a plurality of wound wire turns 5.9, a slider stop buffer 5.11, a left slider guide rail 5.15, a right slider guide rail 5.13, and the slider button 5.5 that is disposed, fixed to, and moves in unison with the slidable magnetic steel toroid substrate 5.31 (shown in FIG. 5d and FIG. 5e) that contains the magnetic steel toroid 5.21 with its centre through hole 5.23.

FIG. 5c is a frontal perspective drawing 502 of the second embodiment of the present invention showing the top cover 5.3 removed and exposing the disposed typical ISM Band radio transceiver circuit module 5.17. This drawing 502 also shows the slider button 5.5 disposed on the magnetic steel toroid substrate 5.31 (shown in FIG. 5d and FIG. 5e) that has disposed the magnetic steel toroid 5.21 with its through hole 5.23 that travels in unison with the magnetic steel toroid substrate 5.31.

FIG. 5d is a right-side drawing view of the second embodiment of the present invention showing the OFF (power) position (by design) when the second embodiment is considered as a battery-less and wireless transceiver module 5.17 (ISM Band of frequencies; 868 MHz, 902-928 MHz, and 2.4 GHz). The simultaneous position of the three components; slider substrate 5.31, the magnetic steel toroid 5.21, and the sliding button 5.5 and they all in unison move (slide) in two opposite positions, a first ON position at one distal position, and a second OFF position at an opposite distal position; sliding across the top cover plate 5.5. These ON-to-OFF & OFF-to-ON opposite distal positions that describe different periods of power generation by the second embodiment energy harvesting generator. Therefore, in FIG. 5d the slider button OFF position has and is identified by the end position of the magnetic steel toroid substrate 5.31 is in mechanical communication (contact) with the sliding magnetic steel toroid substrate stop buffer 5.11 and the left side of the magnetic steel toroid 5.21 is proximally over the Neodymium spherical magnet 5.25 and the right side of the magnetic steel toroid 5.21 is distally away from the Neodymium spherical magnet 5.25. Subsequently, in FIG. 5e the slider button ON position has and is identified by the end position of the magnetic steel toroid substrate 5.31 is “not” in mechanical communication (contact) with the sliding magnetic steel toroid substrate stop buffer 5.11 and the right side of the magnetic steel toroid 5.21 is proximally over the Neodymium spherical magnet 5.25 and the left side of the magnetic steel toroid 5.21 is distally away from the Neodymium spherical magnet 5.25.

FIG. 6a is a right-side view drawing 600 of the second embodiment of the present invention where the focus is on the rank-one magnetic field (flux) tensor 149 is at a “rest” (non-triggered) position, and this “rest” position (t=0) is at a the rank-one magnetic field (flux) tensor 149 position at an angle greater that 90 degrees, caused by the left side of the magnetic steel toroid 105 being magnetically proximal positioned over the Neodymium spherical magnet 109. During the “rest” non-triggered state, the external force f1 equals zero (f1=0) and first repelling disk Neodymium magnet 131 bendable and angular changing top horizontal lever platform 121 angle is zero degrees (Δ=0) with the horizontal plane; as is the bottom repelling second Neodymium disk magnet 133 complex movable and rotatable horizontal elongated lever platform 143. The right side of the magnetic steel toroid 105 is in a position, that is magnetically distal from the Neodymium spherical magnet 109 during this state of pre-triggering “rest period”. Further, in the “rest” state there exists a static attractive magnetic force between the left side of the magnetic steel toroid and the Neodymium spherical magnet 109. Plus, a static magnetic lesser force of attraction that is between the Neodymium spherical magnet 109 and the thin (0.03 mm) metallic glass strip 145. The total magnetic force of attraction causes the rank-one magnetic field (flux) tensor 149 position to exist at an angle greater that 90 degrees with the resultant vectorial force of attraction to be in favour of the magnetic steel toroid 105 to Neodymium spherical magnet 109 force member. The thin strip of metallic glass 145 is incorporated to substantially provide a weak magnetic force of attraction between itself and the Neodymium spherical magnet 109, whose purpose is to provide positional stability for the Neodymium spherical magnet 109 during such times that the entire generator embodiments 600, 601, 602 may exist in a set of locations with different basis vectors of position that is not in a parallel plane referenced to the horizon.

FIG. 6b is an illustration 601 of the preferred embodiment during the time (Δt=1) that an increasing external force (Δf2=x) is beginning to be applied to the top disk magnet bendable and angular changing top horizontal lever platform 121 and the distance between the top first repelling disk Neodymium magnet 131 bendable and angular changing top horizontal lever platform 121 and the lower situated second disk magnet 133 complex movable and rotatable horizontal elongated lever platform 143 causing both platforms 121 & 143 to move downward because the first repelling disk Neodymium magnet 131 and the bottom repelling second Neodymium disk magnet 133 are in mutual magnetic repulsion. Due to the applied external force (Δf2=x) the second disk magnet complex movable and rotatable horizontal elongated lever platform 143 begins its forward descending horizontal movement that causes its tip member 127 to come into mechanical communication to transmit the applied external force translation to start moving the magnetic steel toroid substrate 113 to the left; and the disposed magnetic steel toroid 105 moves in unison with it, thus changing the position of the magnetic steel toroid 105 over the proximal distance of the Neodymium spherical magnet 109 to the point where the centre through hole 107 of the magnetic steel toroid 105 is now aligned directly proximal over the Neodymium spherical magnet 109. The left shifting of the magnetic steel toroid 109 causes the Neodymium spherical magnet's 109 magnetic flux lines 149 to instantly pass through the coil winding 103 shifting the vector angle 149 from greater than 90 degrees to 90 degrees, and this movement produces an electron charge flow to travel through the coil winding 103 and an electrical load (e.g. a transmitter circuit) and this produces a voltage drop across the coil end terminals (not shown) connect to the electrical load. The left forward movement of the magnetic steel toroid substrate 113 and magnetic steel toroid 109 causes the ZED spring to increasingly compress, subsequentially storing potential energy in the ZED spring. Note: The vector angle 149 is a resultant representation of the collective magnetic flux lines.

FIG. 6c is an illustration 602 representing the point where the applied force reaches a maximum, where the ZED spring 119 reaches its compressed limit and where the external force suddenly drops to a minimum or instantly to zero. Then the stored potential energy in the ZED spring 119 is free to release all of its potential energy, thus converting it into the kinetic energy that expands the ZED spring 119 and pushing the magnetic steel toroid substrate 113 with its magnetic steel toroid 105 passing back over the Neodymium spherical magnet 109 in the opposite direction moving to the right causing the magnetic flux lines, represented by the resultant vector 149 to instantly move in the reverse direction; and this action generates electron charge flow in the opposite direction with the end result of producing a voltage of opposite polarity, at the coil terminal ends, to that of the polarity in FIG. 6b. There is in turn the pushing back of the magnetic steel toroid substrate 113 to its initial rest state where the combination of the complex movable and rotatable horizontal elongated lever platform 143 and the complex axle 123 brings all to their initial horizontal position with the horizon. Both the complex movable and rotatable horizontal elongated lever platform 143 and the complex axle 123 move backwards to the right until the complex axle 123 comes in mechanical contact communication with the stop protrusion 129 that is a member component on the limit stop 125 that is a component on the coil bobbin 103; and all moving members stop at the pre-triggered (rest) position. During the time duration of the initial application of an external downward force f1 on the first magnet bendable and angular changing top horizontal lever platform 121 to the cessation of the applied external force f1, a sinusoidal waveform is produced at the coil terminal ends.

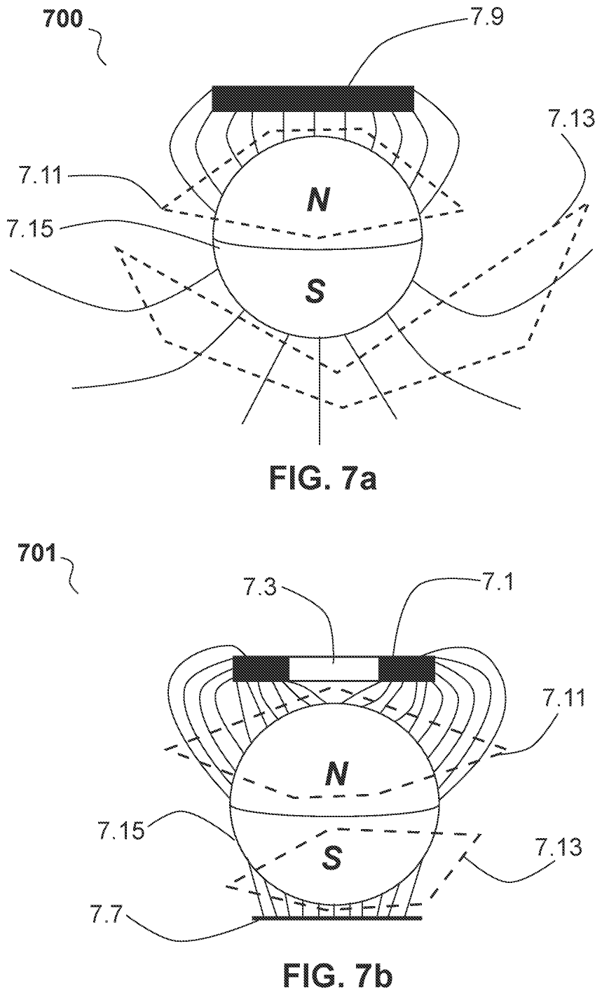

FIG. 7a is an illustration 700 of a spherical magnet 7.15 with a magnetic thin steel slab 7.9 disposed proximal over the spherical magnet 7.15. The magnetic flux field lines on the spherical magnet's South Pole S are moderately distributed extending outward through the circumscribed bottom area 7.13 whereas being the case, the magnetic thin steel slab 7.9 is strongly attractive to the spherical magnet's North Pole N causing the magnetic flux field lines to be more concentrated in the top area 7.11 due to this magnetic attraction between the North Pole N and the thin slab of magnetic steel 7.9. Therefore, if the thin magnetic steel slab 7.9 moves in any direction so will the spherical magnet 7.15 and this instance assumes that there are circumstances that keep the magnetic steel thin slab 7.9 and the spherical magnet 7.15 separated proximally separated during such movements.

In FIG. 7b it is shown in the illustration 701 that a magnetic steel toroid 7.1 with a centre through hole 7.3 that is placed proximally over the spherical magnet 7.15, and a thin (0.03 mm) metallic glass strip proximal distance away from the bottom of the spherical magnet has an operational advantage in utilization for the preferred embodiment of the present invention to have better control of movement of a spherical magnet 7.15 compared to the described arrangement explained in FIG. 7a.

In FIG. 7b it shows the spherical magnet 7.15 at a proximal distance under the magnetic steel toroid 7.1 with its centre through hole 7.3 and with this arrangement there also is a thin (0.03 mm) metallic glass strip 7.7 that is with a substantial width that is equal to or greater than the diameter of the spherical magnet 7.15. In this arrangement, the North Pole N magnetic flux field lines 7.11 are concentrated on both the left and right volume of the magnetic steel toroid 7.1 and with the centre through hole 7.3, and the magnetic flux field lines 7.13 are not concentrated in the surrounding volume of the through hole 7.3. In this arrangement, as the magnetic steel toroid 7.1 moves to the right passing over the spherical magnet 7.15 and the spherical magnet 7.15 rotates to the right following the magnetic steel toroid 7.1 due to the magnetic coupling 7.11 between the magnetic steel toroid's 7.1 magnetic field and the spherical magnet's 7.15 North Pole N and instantly below the thin metallic glass strip 7.7 has magnetic coupling 7.13 with the spherical magnet's 7.15 South Pole S substantially less than the magnetic coupling 7.11 of the magnetic steel toroid 7.1 and the spherical magnet's 7.15 North Pole N this thin strip of metallic glass 7.7 with its high permeability adds some magnetic dragging and causes the spherical magnet 7.15 in position during the triggering and de-triggering times so that there is more stability for rotation when at times the entire generator may be experiencing movements on a possible plurality of placements during operation in any three dimensional space coordinates.

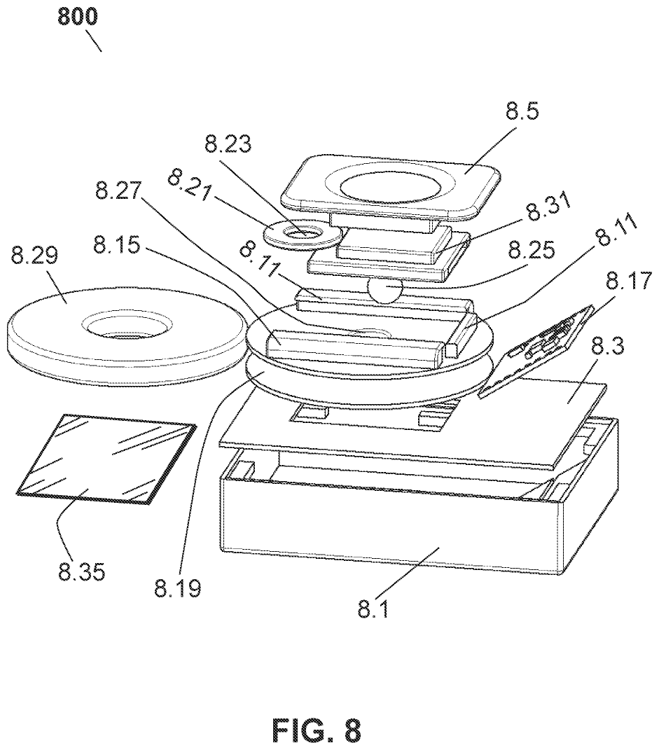

FIG. 8 is an exploded view 800 of another embodiment of the present invention that is not operating as a shoe-heel generator like that of FIG. 1, FIG. 2a and FIG. 2b, rather it is another embodiment type that is utilized as a slide switch generator that powers an ISM Band RF transmitter or a RF transceiver to send encoded digital signal information to a remote RF receiver or RF transceiver for turning on and off electrical loads such as motors, lights, remote controlled lighting systems, automatic remote control gates and other types of semaphore applications. This second embodiment 800 of the present invention has the following components that are in number and function the following: a system enclosure 8.1, an enclosure top cover 8.3, a coil bobbin 8.19, coil winding 8.29, a pair of guide rails 8.15 & 8.11 for the sliding magnetic steel toroid substrate 8.31, the magnetic steel toroid 8.21, Neodymium spherical magnet 8.25, a sliding magnetic steel toroid limit stop 8.37, a thin (0.03 mm) metallic glass high permeability strip 8.35, an RF transmitter module 8.17, and a push button that is disposed and fixed on the magnetic steel toroid sliding substrate 8.5. The second embodiment in FIG. 8 operates in the same manner as the shoe-heel embodiment of the present invention in FIG. 1, FIG. 1A, FIG. 2a & FIG. 2b, FIG. 3a & FIG. 3b, FIG. 4a, FIG. 4b, FIG. 4c, FIG. 6a, FIG. 6b, and FIG. 6c; with the exception that there is no need for any type of mechanical spring member because the “ON” and “OFF” state changes behave as a bi-stable system as a result of the magnetic attraction between the magnetic steel toroid 5.21, which has a centre through hole 5.23, and the Neodymium spherical magnet 5.25. The through hole 5.23 is responsible for the bi-stable characteristic action by creating a discontinuity (hole) in the permeability between the left and right sections of the magnetic steel toroid magnetic steel 5.21. In a dynamical system, bistability means the system has two stable equilibrium states. Something that is bi-stable can be resting in either of two states. An example of a mechanical device which is bistable is a light switch. A bi-stable light switch lever is designed to rest in the “ON” or “OFF” position, but not between the two. In a dynamical system, bistability means the system has two stable equilibrium states. Something that is bistable can be resting in either of two states. An example of a mechanical device which is bistable is a light switch. The switch lever is designed to rest in the “on” or “off” position, but not between the two. As with the first embodiment, the second embodiment also has a thin (0.03 mm) metallic glass high permeability strip 8.35 whose function is to omnidirectionally stabilize the spherical magnet in any basis vectorial three-dimensional space and to keep any movement of the spherical magnet quiet during omnidirectional triggered rotational motion.

The Importance of the Inverse Cube Law for the Present Embodiments

Countless variations leading to prior art of granted patents for generators and motors, based on the principle of electromagnetic induction, have displayed in their workings that moving a magnet through a coil or moving a coil past a magnetic field, and in both cases the right hand rule, also the sine function, predicts the amount of electromotive force (induced voltage) is maximum during the time that the magnetic lines of force are in motion at +/−90° (perpendicular) to the coil winding. The mathematical sign of the right angle is either the velocity function or its complex conjugate for forward and reverse movement of the coil or the magnet in all instances; and further the magnetic force relationship erroneously is described by relating to the inverse square law, where in fact this is only true at atomic distances. When Special Relativity is utilized in calculations at a macro scale as with the force between two magnets, the inverse cube law prevails in proper calculations because this deals with dipoles and not point charges that are the inner workings of dipoles.

It is unfortunate that the inverse cube law is still somewhat esoteric to most. There are many papers published in which scientists have spent considerable time, effort, and funds, to explain experimentally confirmed inverse cube dependency for cases in which according to the simple laws based on point entities, should instead have given an inverse square dependency. The simple mathematical analysis included here will hopefully avoid such waste of resources in the future and teach that the present invention utilizes this inverse cube law to explain the novelty of the present embodiments of the invention.

We learn that the force between two charges, two magnetic monopoles, or two masses all follow an inverse square law, however, most of the time, the scientific reader is not made aware of an important assumption, that of being able to model these entities as point objects; which Maxwell's equations also ascribe to.

If the entities cannot be reduced to a point, then, the inverse square laws cannot be applied. It can be shown mathematically that the inverse square law changes into an inverse cube law approximation for the case of dipoles.

In practice, a physicist finds that most of real-life applications cannot be modeled by point entities, but only by dipoles. These dipoles are commonly met in dielectrics, magnets, and molecules. In magnetism, nobody has yet identified a magnetic particle which can be defined as a point monopole. All physical magnets to date are in fact known to consist of dipoles having a north and a south pole and their force field will therefore always follow the inverse cubed law for dipoles. Same applies to charges acting on electric dipoles, and one cannot exclude the theoretical possibility of the same applying to mass dipoles.

### Mathematical Derivation of the Inverse Cubed Law

This derivation theoretically applies to all forces, which obey the inverse square law when applied to point entities (FP).

Electrostatic Force: FP=K(Q1×Q2)/R2 . . . K=1/4π εο, Q=charge, R=distance Magnetic Force: FP=U(m1×m2)/R2 . . . U=1/μ, m=magnetic monopoles strength, R=distance

Gravitational Force: FP=G(M1×M2)/R2 . . . G=gravitational constant, M=mass,

R=distance

So, in general FP=k(X1×X2)/R2

where FP=force magnitude for point entities, k=constant, X=entity unit,

R=distance between entities.

Now defined is an additional parameter δ which in practice is a short distance between two-point entities forming a single dipole.

Distance R will therefore define the much longer distance between the centre of the dipole and another point entity X.

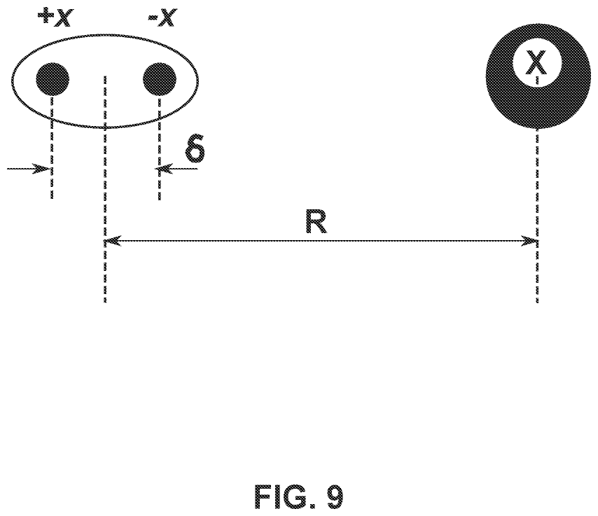

FIG. 9 is a diagram of the dipole that is made up of two opposite entities +x and −x separated by a distance δ, acted at a much larger distance R by the point entity +X. Since the negative part of the dipole is attracted to +X, the dipole will orientate itself with the negative side facing +X point entity. Thus if we measure distance R from the centre point of the dipole to point +X, we find that the distance from +X to +x is R+δ/2 and that from +X to −x is R−δ/2. Therefore, since the distance between +X and −x is shorter than that between +X and +x, the force polarity between two opposite entities will govern the motion of the dipole with respect to the point entity. For opposite charges and magnetic poles, this means that a dipole will always move toward point +X, independently of the polarity of X.
The net force (FD) acting between the dipole and point entity X will be:

FD=k(X{x/(R−δ/2)2})−k(X{x/(R+δ/2)2}) (eq.1)
we can rewrite the above in the form:

FD=[k{X(x/R2)}]/(1−δ/2R)2−[k{X(x/R2)}]/(1+δ/2R)2 (eq.2)
For the condition δ<<2R, which was set as one of our assumptions, we are justified to apply the binomial approximation:

(1+x)n≈1+nx, or 1/(1+x)n=(1+x)−n≈1−nx, valid for x<<1. (eq.3)

This reduces: 1/(1−δ/2R)2=(1−δ/2R)−2 to 1+δ/R, (eq.4)

and 1/(1+δ/2R)2=(1+δ/2R)−2 to 1−δ/R (eq.5)
The force field equation can therefore be approximated as:

FD≈[k{X(x/R2)}](1+δ/R)−[k{X(x/R2)}](1−δ/R) (eq.6)

FD≈[kX(x/R2)](1+δ/R−1+δ/R) (eq.7)

FD≈2k[X(xδ/R3)] or simply FDα1/R3 (eq.8)

As is obvious from the above mathematical analysis, the simple inverse square law relation given for point charges, magnetic monopoles or point masses does NOT apply for the simple dipole case, for which the inverse cube law must be applied. It is also shown that the force vector between a dipole and a point entity is always the same polarity as that given for two opposite polarity point entities, which in general is defined as an attractive force.

All static dipolar fields drop off as the inverse cube of distance (Gauss's Law) once it gets much further away than the distance between the two poles of the dipole. It can thought of as being the case because the monopole fields of the two poles cancel each other “to first order”.

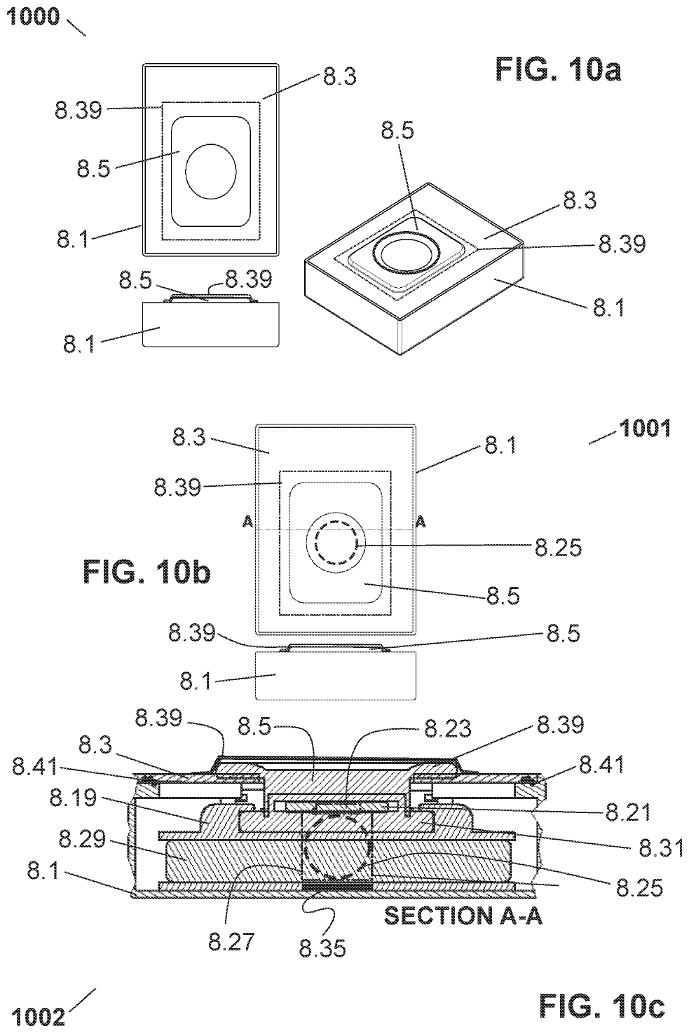

By the same token, the quadrupole field (from two opposite dipoles right next to each other) drops off as the inverse 4th power of distance, because the two dipoles cancel each other to first order; and so on.
FIG. 10a is a perspective overview of a special case for the second embodiment as described in FIG. 3 (all), FIG. 4 (all), FIG. 5 (all), and FIG. 6 (all) that is a hermetically-sealed second embodiment 1000, 1001, 1002 that is waterproof and air-tight by utilizing a special substantially thin polymer cover 8.39 that is disposed air and water tight over the slide button 8.5 and is substantially flexible to allow for the functional ON/OFF sliding of the slide button 8.5 whose function is utilized for the same reason as is utilized in FIG. 3 (all), FIG. 4 (all), FIG. 5 (all), and FIG. 6 (all). In addition, utilizing a thin (0.03 mm) metallic glass strip 8.35 that is substantially attracted by magnetic induction and proximal separated by the bottom blind hole thin blind end to the spherical magnet 8.25 to allow for uniform operation in any position in three dimensional space by being proximally attracted to the spherical magnet 8.25; and it also retards the spherical magnet's 8.25 rotation to lengthen the time duration of the generated waveform, thus reducing the frequency of the voltage waveform generated and increasing its ringdown time, which allows for an substantial increase in useable operational time that can allow for more data to be transmitted for greater use in the case of the transmitter being a transceiver and in some applications can be powered long enough for a return annunciation signal sent from the remote control transceiver in cases where safety is demanded. The retardation of the time duration results in performing a Fourier analysis of the waveform and then taking the Laplace transform to identify a damped sinewave:

y(t)=A·e^{-λt}·(cos(ωt+ϕ)+(sin(ωt+ϕ)))

y(t)=A·e^{-λt}·(cos(ωt+ϕ))
Where:
A is the initial amplitude (the highest peak),
λ is the decay constant,
φ is the phase angle (at t=0)
ω is the angular frequency.
The mathematical relationship is that the lower the frequency of the sinewave generated, the longer the Laplace intrinsic damping factor, which in effect produces a longer period for generating usable electrical power to operate the transmitter module.

The present invention is not restricted to the particular details described herein. Many other variations of the foregoing description and drawings may be made within the scope of the present invention. For example, an electrical generator of the type described in U.S. patent application Ser. No. 16/675,401 filed on Nov. 6, 2019, and cross referenced above, may also be used. Accordingly, it is the following claims including any amendments thereto that define the scope of said present invention.

What is claimed is:

1. An energy harvesting electrical generator configured to convert kinetic mechanical energy into electrical energy comprising;
a coil winding of a plurality of turns of wire wound around a coil bobbin having a set of distal opposite parallel guide rails;
a magnet disposed in a blind hole within the center of said coil bobbin;
a magnetic toroid with a center through hole;
a slidable substrate for housing said toroid;
a bendable horizontal platform disposed on said coil bobbin;
a movable and rotatable horizontal elongated lever platform associated with said horizontal platform;
an axle member received by lever platform;
a first repelling magnet disposed on said bendable horizontal platform;
a second repelling magnet disposed on said movable and rotatable horizontal elongated lever platform;
a lever stop member disposed on said complex coil bobbin;
an axle stop member disposed on said lever stop member;
a spring that converts mechanical kinetic energy into stored mechanical potential energy;
a set of protrusions disposed on said complex coil bobbin for capturing said spring;
a strip of metallic glass disposed on the bottom surface of said complex coil bobbin that is centered beneath said spherical magnet contained in said blind hole;
and an enclosure in the form of a typical shoe heel for receiving components mentioned above.

2. The electrical generator of claim 1, wherein:
said coil winding has two end wire terminals for connecting to an electrical load.

3. The electrical generator of claim 1, wherein:
said center through hole of said magnetic steel toroid is half the diameter of an outer diameter of said magnetic steel toroid.

4. The electrical generator of claim 1, wherein:
said complex coil bobbin has two distal separate parallel insert magnetic steel toroid substrate slide rail guides disposed on two opposite top planar sides.

5. The electrical generator of claim 1, wherein:
a first elongated rectangular blind hole is disposed on one side of said horizontal plane substrate.

6. The electrical generator of claim 1, wherein:
said substrate for said horizontal orientated magnetic steel toroid is free to slide horizontally through said rail guides disposed on two opposite top planar sides.

7. The electrical generator of claim 1, wherein said magnetic is a spherical Neodymium magnet and:
a second elongated rectangular blind hole is disposed on a side opposite said first elongated rectangular blind hole disposed on one side of said magnetic steel toroid horizontal plane substrate, and wherein the second elongated rectangular blind hole is disposed on a side opposite said first elongated rectangular blind hole to accept a compression spring's free compressible end that is opposite to a fixed compression spring end that is disposed and fixed in two opposite cylindrical slit protrusions disposed on said top planar surface of said coil bobbin so as to be situated on one end in line centrally with said slide rails; and where said slide rails guide said magnetic steel toroid substrate bi-directionally proximal over said Neodymium spherical magnet.

8. The electrical generator of claim 1, wherein said magnetic is a spherical Neodymium magnet and:
said thin metallic glass strip has a thickness of 0.03 millimeters and a length substantially greater than said Neodymium spherical magnet's diameter, and a width that is asymptotically valued to that of said Neodymium spherical magnet's diameter.

9. The electrical generator of claim 1, wherein said magnetic is a spherical Neodymium magnet and:
said thin metallic glass strip is disposed centrally in a receiving compartment on the underside of said complex coil bobbin and fixed therein proximally and directly beneath said Neodymium spherical magnet and a proximal separation distance is defined by a thin layer that is part of an underside partition of said coil bobbin.

10. The electrical generator of claim 1, wherein:
said Neodymium spherical magnet is free to rotate with its said centre blind hole compartment; and said rotation is governed by said sliding in unison of said magnetic steel toroid substrate and said magnetic steel toroid as said magnetic steel toroid substrate passes bi-directionally over said Neodymium spherical magnet.

11. The electrical generator of claim 1, wherein:
Said bendable and angular changing horizontal platform contains a first repelling disk Neodymium magnet that is there disposed and fixed within said cylindrical magnet compartment of said horizontal platform.

12. The electrical generator of claim 1, wherein:
said bendable and angular changing horizontal platform is attached and fixed, by twin columns, on opposite sides of said horizontal platform; and said columns are also attached and fixed on said top end surface opposite to said end of said compression spring dual cylindrical slit protrusions on said top surface plane of said coil bobbin; with said twin columns and consequently said horizontal platform are centered in line with said blind hole compartment in the bobbin.

13. The electrical generator of claim 1, wherein:
Said movable and rotatable complex horizontal elongated lever member has a Neodymium cylindrical magnet compartment, which has disposed therein said second Neodymium disk magnet, which is at one end of said complex horizontal elongated lever member; and this end is aligned and situated proximal under said bendable and angular changing horizontal platform; and at an end opposite that of said cylindrical Neodymium second disk magnet compartment, there exists a lateral elongated push tip member that is utilized as a means for mechanically communicating by touch and push contact with said slidable magnetic steel toroid substrate.

14. The electrical generator of claim 1, wherein:
A mechanical connection between said movable and rotatable complex horizontal elongated lever member and said complex axle member exists by a snap-in fitted union between said two members; and said movable and rotatable complex horizontal elongated lever member is free to axially rotate about said complex axle's dual end axle protrusions disposed each on opposite sides of said complex axle member; and said complex axle member is free to rotate about said coil bobbin's first limit stop section disposed on said front centre end of said coil bobbin; and that front centre location is opposite to said dual spring insertion slit dual separate protrusions that are in line distal separated from each other; said coil bobbin's first limit stop section having dual protrusions distally separated inline and opposite to each other; and said dual protrusions are utilized as distance rotational travel limit stop.

15. The electrical generator of claim 1, wherein:
movement of said magnetic steel toroid substrate is functional as a vehicle for transporting said magnetic steel toroid for said bi-directional sliding movement of said magnetic steel toroid proximally passing over said magnet disposed within said bobbin; and said sliding bi-directional magnetic steel toroid movement causes said magnet to rotate, by mechanical-magnetic induction coupling within said magnet's blind hole compartment that is centred within said coil bobbin; and where said magnet's rotation is bi-rotational travel directly caused by said mechanical-magnetic induction coupling; and said resultant of this action is generating an alternating current of electron charge flow that provides electrical power to an electrical load; and said load can be a RF (Radio Frequency) transmitter to operate a remote control RF receiver system that is capable of controlling remotely, the ON and OFF power states in electrical loads.

16. The electrical generator of claim 1, wherein:
said electrical generator in said preferred embodiment is incorporated into a typical heel of a shoe; and said shoe will have fixed permanently said generator inside said shoe heel; and any movement by walking and running will automatically trigger said transmitter by said generator; and said walking and running that triggers power by said action sequences of claim 16 that activates said RF transmitter to transmit radio telegrams for identification and tracking of a wearer of said shoe with said generator installed in said shoe.

17. A electrical generator configured to convert mechanical kinetic energy into electrical energy for the purpose of powering a RF transmitter for sending transmissions, wherein said electrical generator comprising;
an enclosure;
a top cover fitted to said enclosure;
a bobbin;
a coil winding on said bobbin;
a spherical magnet disposed for rotation in said bobbin;
a substantially flat magnetic steel toroid;
a substrate for carrying said magnetic steel toroid;
a metallic glass strip disposed on a bottom surface of said bobbin;
a slide button connected to the substrate; and
an RF transmitting circuit connected to said coil winding.

18. The electrical generator of claim 17, wherein:
the coil wounding has two output terminal wire ends for connection to electrical loads; and said bobbin is disposed within said enclosure; and said fitted top cover has a rectangular through hole to accommodate said slide button to pass through and have a fitted mechanical connection to said substrate.

19. The electrical generator of claim 17, wherein:
a magnetic steel toroid configured with a center through hole; and said through hole is sized with a diameter half that of said toroid's outer diameter; and where said toroid is disposed through said rectangular blind hole in a plane parallel to said substrate's horizontal plane; and fixed centrally within said substrate; and
both said toroid and said substrate move in unison simultaneously sliding proximally bi-directionally over said spherical magnet.

20. The electrical generator of claim 17, wherein:
said spherical magnet is a Neodymium magnet, and said bobbin has a circular blind hole centred through said bobbin; and configured with a sized hole that allows substantial freedom for said spherical magnet to rotate with six degrees of rotational freedom.

21. The electrical generator of claim 17, wherein:
said slide button that is mechanically connected to said toroid substrate and is the connection conduit for the application of an external sliding force (e.g. from a finger).

22. The electrical generator of claim 17, wherein:
said thin metallic glass strip has a thickness of substantially 0.03 millimeters+/−1% and a length substantially greater than the diameter of said spherical magnet, and a width diameter that is asymptotically valued to that of said Neodymium spherical magnet's diameter.

23. The electrical generator of claim 17, wherein:
said thin metallic glass strip is disposed centrally on the underside of said bobbin that is inserted into its receiving compartment and therein fixed proximally and directly beneath said spherical magnet that is disposed within its blind hole compartment, and said proximal separation distance is defined by a thin layer that is part of said coil bobbin's underside partition existing as the blind end of said blind hole compartment.

24. The electrical generator of claim 17, wherein:
said RF transmitting circuit is a module disposed within said enclosure and is electrically connected to said generator.

25. The electrical generator of claim 17, wherein:
movement initialed by an external bidirectional sliding force applied to said slide button mechanically connected to said substrate is functional as a vehicle for transporting said magnetic steel toroid for said bi-directional sliding movement of said magnetic steel toroid proximally passing over said spherical magnet;
and said sliding bi-directional magnetic steel toroid movement causes said spherical magnet to rotate, by mechanical-magnetic induction coupling within said spherical magnet's blind hole compartment that is centred within said coil bobbin; and where said spherical magnet's rotation is bi-rotational travel directly caused by said mechanical-magnetic induction coupling; and said resultant of this action is generating an alternating current of electron charge flow in said coil that provides electrical power to an electrical load; and said load is a RF (Radio Frequency) transmitter to operate a remote control RF receiver system that is capable of controlling remotely, the ON and OFF power states in electrical loads.

26. The electrical generator of claim 17, wherein:
a hermetically-sealed substantially flexible polymer material is disposed and substantially covers said slide button to render said enclosure hermetically-sealed, air tight and water tight so that operation is not compromised.
